(19) United States
(12) Patent Application Publication
(10) Pub. No.: US 2017/0024947 A1
(43) Pub. Date: Jan. 26, 2017

(54) VOTING DEVICE AND VOTING SYSTEM USING SAME

(71) Applicant: ENNOCONN CORPORATION, New Taipei (TW)

(72) Inventor: MING-HSUEH TSAI, New Taipei (TW)

(21) Appl. No.: 14/833,538

(22) Filed: Aug. 24, 2015

(30) Foreign Application Priority Data
Jul. 23, 2015 (TW) 104123949

(51) Int. Cl. G07C 13/00; G06F 3/0484; G06K 19/06

(52) U.S. Cl. CPC G07C 13/00; G06K 19/06028; G06F 3/04842

(57) ABSTRACT

A voting device includes a touch panel and a rechargeable battery, the voting device being part of a voting system. The touch panel is configured to display a topic under discussion and options relating thereto. The touch panel is also configured to output data as to vote or option chosen by a voter through a wireless network, together with barcode data identifying the voter. The rechargeable battery supplies power to the voting device. A voting system using the voting device and allowing instant calculation and display of the voting result is also provided.

### FIELD

The subject matter herein generally relates to voting devices and voting systems.

### BACKGROUND

Paper ballots and manual counting are used in traditional voting, which is not efficient.

### BRIEF DESCRIPTION OF THE DRAWINGS

Implementations of the present technology will now be described, by way of example only, with reference to the attached figures.

FIG. 1 is a block diagram of an embodiment of a voting system, the voting system comprising a voting device and a cloud computing center.

FIG. 2 is a diagrammatic view of an embodiment of the voting device of FIG. 1.

FIG. 3 is a block diagram of an embodiment of the cloud computing center of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure relates to a voting system 100.

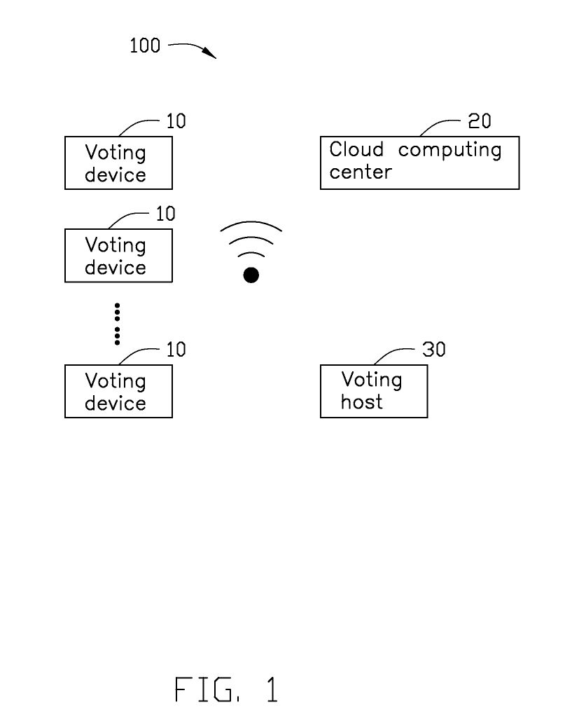

FIG. 1 illustrates an exemplary embodiment of the voting system 100. The voting system 100 can comprise a plurality of voting devices 10, a cloud computing center 20, and a voting host 30. The voting devices 10, the cloud computing center 20, and the voting host 30 are coupled to each other through a wireless network.

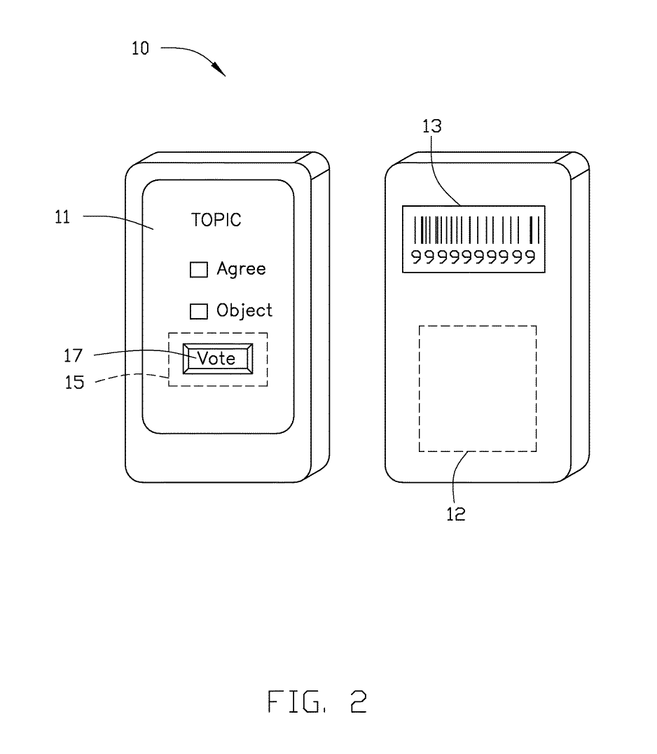

FIG. 2 illustrates an exemplary embodiment of the voting device 10. The voting device 10 can comprise a touch panel 11, a rechargeable battery 12, and a barcode 13. The touch panel 11 is configured to allow voting by touch. In at least one embodiment, the touch panel 11 is configured to display a topic and selectable options corresponding to the topic or possible votes related thereto and configured to render data as to vote chosen (voting data) based on at least one selected option through the wireless network. In other embodiments, content displayed on the touch panel 11 can be set according to need.

The rechargeable battery 12 is configured to supply power to the voting device 10 for easy portability. The barcode 13 is configured to be strictly associated with a certain voter. In at least one embodiment, the barcode 13 is on behalf of identity information of the voter. When the voting data is outputted from the voting device 10, the identity information of the voter is also outputted from the voting device 10.

In other embodiments, the voting device 10 also comprises a voting module 15. The voting module 15 can comprise a voting button 17. When the voting button 17 is pressed, the voting data and the identity information are outputted from the voting device 10.

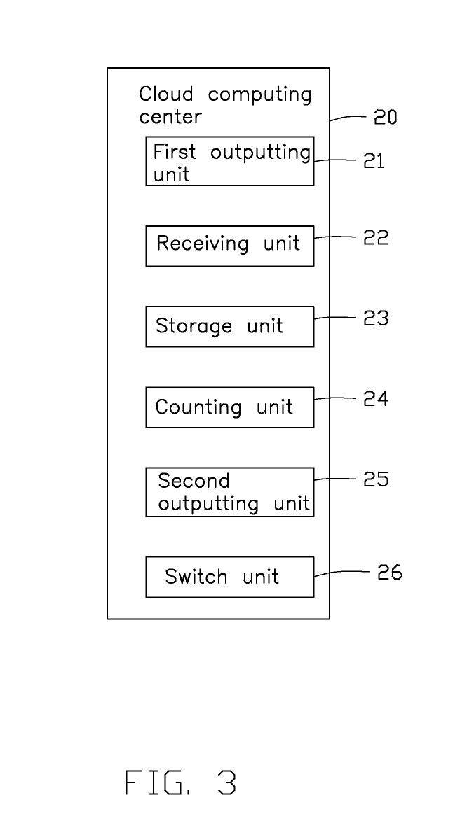

FIG. 3 illustrates an exemplary embodiment of the cloud computing center 20. The cloud computing center 20 can comprise a first outputting unit 21, a receiving unit 22, a storage unit 23, a counting unit 24, a second outputting unit 25, and a switch unit 26. The first outputting unit 21 is configured to output one topic under discussion to all the voting devices 10 and the voting host 30. The receiving unit 22 is configured to receive the voting data and the corresponding identity informations from each voting device 10 through the wireless network. The storage unit 23 is configured to store a plurality of topics. The storage unit 23 is also configured to store the voting data and the corresponding identity informations from each voting device 10. The counting unit 24 is configured to count the votes of the voting data from each voting device 10 to establish instant voting result. The second outputting unit 25 is configured to output the voting results. The switch unit 26 is configured to change the topics displayed on the voting devices 10 and the voting host 30 according to need.

In use, the cloud computing center 20 outputs the one topic under discussion to each voting device 10 and the voting host 30 through the wireless network. The topic under discussion and the corresponding options or votes relating thereto are displayed on the voting device 10. Voters can touch the touch panel 11 for voting. The cloud computing center 20 receives the voting data and the corresponding identity information from each voting device 10 through the wireless network, counts the votes within the voting data, and calculates instant result. When the next topic is needed to be vote, the switch unit 26 of the cloud computing center 20 changes the topic displayed on the voting devices 10 and the voting host 30 accordingly.

The embodiment shown and described above is only example. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. A voting device comprising:
a touch panel configured to display a topic and selectable options corresponding to the topic and render voting data based on at least one selected option; and
a rechargeable battery configured to supply power to the touch panel.

2. The voting device of claim 1, further comprising a barcode, the barcode configured to be on behalf of identity information of the voter, wherein the identity information of the voter is outputted from the voting device in event the voting data is outputted from the voting device.

3. The voting device of claim 1, wherein the content displayed on the touch panel is set according to need.

4. The voting device of claim 1, further comprising a voting module, the voting module comprising a voting button, wherein the voting data and the identity information are outputted from the voting device in event the voting button is pressed.

5. A voting system comprising:
a plurality of voting devices, each voting device comprising:
a touch panel configured to display a topic under discussion and corresponding options and output a voting data according to a choice of a voter in touching through a wireless network; and
a rechargeable battery configured to supply power to the voting device;
a voting host coupled to each voting device through the wireless network; and
a cloud computing center coupled to each voting device and the voting host through the wireless network, wherein the cloud computing center is configured to receive the voting data from each voting device through the wireless network and count the voting data to get voting result instantly.

6. The voting system of claim 5, wherein the voting device further comprises a barcode, the barcode is configured to be on behalf of identity information of the voter, the identity information of the voter is outputted from the voting device in event the voting data is outputted from the voting device.

7. The voting system of claim 5, wherein the content displayed on the touch panel is set according to need.

8. The voting system of claim 5, wherein the voting device further comprises a voting module, the voting module comprising a voting button, wherein the voting data and the identity information are outputted from the voting device in event the voting button is pressed.

9. The voting system of claim 6, wherein the cloud computing center comprises a first outputting unit, a receiving unit, a storage unit, a counting unit, and a second outputting unit, the first outputting unit is configured to output the one topic under discussion to the all voting devices and the voting host, the receiving unit is configured to receive the voting data and the corresponding identity informations from each voting device through the wireless network, the storage unit is configured to store a plurality of topics and configured to store the voting data and the corresponding identity informations from each voting device, the counting unit is configured to count the votes of the voting data from each voting device for establishing instant voting result, the second outputting unit is configured to output the voting result.

10. The voting system of claim 9, wherein the cloud computing center further comprises a switch unit, the switch unit is configured to change the topics displayed on the voting devices and the voting host according to need.
